(19) United States
(12) Patent Application Publication
(10) Pub. No.: US 2022/0025492 A1
(43) Pub. Date: Jan. 27, 2022

(54) Metallurgical Compositions for Press-and-Sinter and Additive Manufacturing

(71) Applicant: Hoeganaes Corporation, Cinnaminson, NJ (US)

(72) Inventors: Christopher Schade, Marlton, NJ (US); Kerri Horvay, Philadelphia, PA (US); Simon Hoeges, Overath (DE); Philipp Gabriel, Breckerfeld (DE)

(21) Appl. No.: 17/312,029

(22) PCT Filed: Mar. 9, 2020
(86) PCT No.: PCT/US2020/021629

§ 371 Date: Jun. 9, 2021

Related U.S. Application Data
(60) Provisional application No. 62/818,193, filed on Mar. 14, 2019.

(51) Int. Cl. C22C 38/12; B33Y 70/00; C22C 38/04; C22C 38/02; B22F 1/00

(52) U.S. Cl. CPC C22C 38/12; B33Y 70/00; B33Y 10/00; C22C 38/02; B22F 1/0007; C22C 38/04

(57) ABSTRACT

The disclosure provides iron-based metallurgical compositions comprising iron and alloying elements of about (0.01) to about (0.65) wt %, based on the weight of the composition, of carbon; about (1) to about (2.0) wt %, based on the weight of the composition, of molybdenum; about (0.25) to about (2.0) wt %, based on the weight of the composition, of manganese; about (0.25) to about (2.0) wt %, based on the weight of the composition, of silicon; and about (0.05) to about (0.6) wt %, based on the weight of the composition, of vanadium. In some embodiments, the iron-based metallurgical composition is a powder metallurgical composition.

### CROSS REFERENCE TO RELATED APPLICATIONS

This application claims benefit under 35 U.S.C. § 119(e) of U.S. Provisional Patent Application No. 62/818,193, filed Mar. 14, 2019, the contents of which are hereby incorporated by reference in its entirety.

### TECHNICAL FIELD

The present disclosure relates to iron-based metallurgical compositions and methods of preparing and using same, and in particular to iron-based powder compositions that can be used in press-and-sinter applications and additive manufacturing methods.

### BACKGROUND

Iron-based particles have long been used as base materials for use in and the preparation of compacted metal parts and more recently in additive manufacturing (AM).

What is needed are iron-based compositions that can be used in both additive manufacturing and/or traditional press-and-sinter applications to provide high strength, high ductility metals.

### SUMMARY

The disclosure provides iron-based metallurgical compositions comprising iron and alloying elements of about 0.01 to about 0.65 wt %, based on the weight of the composition, of carbon; about 1 to about 2.0 wt %, based on the weight of the composition, of molybdenum; about 0.25 to about 2.0 wt %, based on the weight of the composition, of manganese; about 0.25 to about 2.0 wt %, based on the weight of the composition, of silicon; and about 0.05 to about 0.6 wt %, based on the weight of the composition, of vanadium. In preferred embodiments, the iron-based metallurgical composition is a powder metallurgical composition.

In more preferred embodiments, the iron-based powder metallurgical composition comprises, as alloying elements, about 0.05 to about 0.54 wt %, based on the weight of the composition, of carbon; about 1.26 to about 1.4 wt %, based on the weight of the composition, of molybdenum; about 0.93 to about 1.25 wt %, based on the weight of the composition, of manganese; about 0.93 to about 1.15 wt %, based on the weight of the composition, of silicon; and about 0.12 to about 0.2 wt %, based on the weight of the composition, of vanadium.

The disclosure further provides pressed and sintered metal parts made from the iron-based metallurgical powder compositions described herein.

The disclosure also provides metal parts made by additive manufacturing using the iron-based metallurgical powder compositions described herein.

The disclosure further provides methods of additive manufacturing a metal part from a metallurgical powder composition such as described above, preferably a composition wherein the metallurgical powder composition comprises iron particles diffusion bonded with one or more of the alloying elements described above.

The disclosure also provides methods of additive manufacturing a metal part from a metallurgical powder composition, wherein the metallurgical powder composition comprises iron and alloying elements of about 0.1 to about 0.65 wt %, based on the weight of the composition, of carbon; about 1 to about 1.6 wt %, based on the weight of the composition, of molybdenum; about 0.75 to about 1.5 wt %, based on the weight of the composition, of manganese; about 0.75 to about 1.5 wt %, based on the weight of the composition, of silicon; and about 0.05 to about 0.3 wt %, based on the weight of the composition, of vanadium; wherein at least a portion of the molybdenum present in the composition is pre-alloyed with the iron in the form of iron/molybdenum particles. Preferably this powder composition is in the form of iron/molybdenum particles to which particles of the alloying elements are diffusion bonded.

Other aspects and embodiments of the invention will be readily apparent from the following detailed description of the invention.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific compositions, methods, devices, and systems disclosed. In addition, the drawings are not necessarily drawn to scale.

FIG. 1 is an image of the alloy of Example 1 showing fine microstructure.

FIG. 2 is an image of a 20 MnCr5 alloy showing a coarser structure than the alloy of Example 1.

### DETAILED DESCRIPTION OF ILLUSTRATIVE EMBODIMENTS

In the present disclosure the singular forms “a”, “an” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about” it will be understood that the particular value forms another embodiment. In general, use of the term “about” indicates approximations that can vary depending on the desired properties sought to be obtained by the disclosed subject matter and is to be interpreted in the specific context in which it is used, based on its function. Where present, all ranges are inclusive and combinable. That is, references to values stated in ranges include every value within that range.

It is to be appreciated that certain features of the invention which are, for clarity, described herein in the context of separate embodiments, may also be provided in combination in a single embodiment. That is, unless obviously incompatible or excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

Accordingly, the present disclosure provides iron-based metallurgical compositions, comprising iron and one or more alloying elements. In some embodiments, the iron-based metallurgical composition is in the form of finely divided base-iron particles and particles of the individual alloying elements. In some embodiments, the base-iron particles are made from iron that has been pre-alloyed with one or more of the alloying elements. In further embodiments, the iron-based metallurgical composition is fully alloyed. In yet further embodiments, the iron-based metallurgical composition is partially alloyed. In other embodiments, the base-iron particles are diffusion bonded with the elemental alloying powders. In further embodiments, the base-iron particles are diffusion bonded with at least some of the elemental alloying powders. In further embodiments, at least some of the base- iron particles are diffusion bonded with the elemental alloying powders. In yet other embodiments, In further embodiments, at least some of the base-iron particles are diffusion bonded with at least some of the elemental alloying powders.

As used herein, the term “iron-based powder compositions” refers to iron-based powders where iron forms the basis (“base-iron”) and major component of the powder. In some embodiments, the iron is the base element. The base-iron can be in the form of a powder or particles of pure or substantially pure iron or iron pre-alloyed with at least one alloying element. In the iron-based powder compositions disclosed herein, the particles of iron or pre-alloyed iron are in combination with powders of the other alloying elements to provide a final composition as in paragraph [0003] above. The particles of iron or pre- alloyed iron can be prepared by gas atomization or water atomization.

“Pure iron” (or “pure iron particles”) as used herein refers to iron containing no more than about 0.01 wt % of normal impurities.

“Substantially pure iron” (or “substantially pure iron particles”) as used herein refers to iron containing no more than about 1.0 wt %, preferably no more than about 0.5 wt % of normal impurities. Examples of substantially pure iron include highly compressible, metallurgical-grade iron powders. Specific examples of substantially pure iron powders include the ANCORSTEEL® 1000 series of pure iron powders, such as the following, wherein the wt % noted therein are based on the total weight of the composition:
A composition comprising iron and less than about 0.01 wt % carbon, less about 0.14 wt % oxygen, about 0.002 wt % nitrogen, about 0.018 wt % sulfur, about 0.009 wt % phosphorus, less than about 0.01 wt % silicon, about 0.2 wt % manganese, about 0.07 wt % chromium, about 0.10 wt % copper, and about 0.08 wt % nickel (also known as ANCORSTEEL® 1000);
A composition comprising iron and less than about 0.01 wt % carbon, about 0.09 wt % oxygen, about 0.001 wt % nickel, about 0.009 wt % sulfur, about 0.005 wt % phosphorus, less than about 0.01 wt % silicon, about 0.10 wt % manganese, about 0.03 wt % chromium, about 0.05 wt % copper, and about 0.05 wt % nickel (also known as ANCORSTEEL® 1000B),
A composition comprising iron and less than about 0.01 wt % carbon, about 0.07 wt % oxygen, about 0.001 wt % nitrogen, about 0.007 wt % sulfur, about 0.004 wt % phosphorus, less than about 0.01 wt % silicon, about 0.07 wt % manganese, about 0.02 wt % chromium, about 0.03 wt % copper, and about 0.04 wt % nickel (also known as ANCORSTEEL® 1000 C),
A composition comprising iron and about 0.01 wt % carbon, about 0.02 wt % silicon, about 0.15 wt % oxygen, and about 0.015 wt % sulfur (also known as ANCORSTEEL® AMH),
A composition comprising iron and about 0.01 wt % carbon, about 0.02 wt % silicon, about 0.15 wt % oxygen, and about 0.015 wt % sulfur (also known as ANCORSTEEL® DWP200), or

Other substantially pure iron powders that can be used herein include sponge iron powders, such as a composition comprising iron and about 0.02 wt % silicon dioxide, about 0.01 wt % carbon, about 0.009 wt % sulfur, and about 0.01 wt % phosphorus (also known as ANCOR MH-100 powder).

The term “alloy” or “prealloy” as used herein refers to a metal, typically iron as in this invention, that is combined with one or more alloying elements to produce a new metal substance. Alloys may be prepared as understood in the art. A typical method for preparing an alloy includes heating a metal, such as iron, and an alloying element until molten. Mixing, followed by solidification provides the alloy. The ANCORSTEEL® low alloy steel powders are substantially pure iron and contain a low level of alloy components. Such low alloy steel powders include, without limitation, the following:
A composition comprising iron and less than about 0.01 wt % carbon, about 0.35 wt % molybdenum, about 0.15 wt % manganese, and about 0.13 wt % oxygen (also known as ANCORSTEEL® 30HP),
A composition comprising iron and less than about 0.01 wt % carbon, about 0.18 wt % manganese, about 0.50 wt % molybdenum, about 0.09 wt % oxygen (also known as ANCORSTEEL® 50 HP),
A composition comprising iron and less than about 0.01 wt % carbon, about 0.12 wt % manganese, about 0.86 wt % of molybdenum, and about 0.08 wt % oxygen (also known as ANCORSTEEL® 85 HP),
A composition comprising iron and less than about 0.01 wt % carbon, about 0.12 wt % manganese, about 1.5 wt % molybdenum, and about 0.08 wt % oxygen (also known as ANCORSTEEL® 150 HP),
A composition comprising iron and less than about 0.01 wt % carbon, about 0.61 wt % molybdenum, about 0.46 wt % nickel, about 0.25 wt % manganese, and about 0.13 wt % oxygen (also known as ANCORSTEEL® 2000), and
A composition comprising iron and about 0.01 wt % carbon, about 0.56 wt % molybdenum, about 1.83 wt % nickel, about 0.15 wt % manganese, and about 0.13 wt % oxygen (also known as ANCORSTEEL® 4600V).

Other prealloyed iron-based powders include the ANCOR AM® powders such as:
ANCOR AM® 17-4PH (comprising iron and about 15.4 wt % chromium, about 0.3 wt % silicon, about 0.4 wt % manganese, about 4.5 wt % nickel, about 3.2 wt % copper, about 0.2 wt % niobium/tantalum, about 0.15 wt % carbon, about 0.02 wt % sulfur, about 0.1 wt % oxygen, and about 0.5 wt % nitrogen),
ANCOR AM® 316L (comprising iron and about 16.5 wt % chromium, about 0.45 wt % silicon, about 1.2 wt % manganese, about 11 wt % nickel, about 2.2 wt % molybdenum, about 0.1 wt % carbon, about 0.3 wt % sulfur, about 0.07 wt % oxygen, and about 0.1 wt % nitrogen),
ANCOR AM® IN625 (comprising iron and about 60.4 wt % nickel, about 21.9 wt % chromium, about 9.4 wt % molybdenum, about 0.45 wt % aluminum, about 3.9 wt % niobium, about 1.1 wt % oxygen, about 0.02 wt % carbon, and about 0.06 wt % nitrogen), or
ANCOR AM® IN718 (comprising iron and about 53.8 wt % nickel, about 18.5 wt % chromium, about 0.5 wt % aluminum, about 5 wt % niobium, about 1 wt % titanium, about 3 wt % molybdenum, about 170.03 wt % carbon, about 0.001 wt % sulfur, about 0.03 wt % oxygen, and about 0.04 wt % nitrogen) powders.
ANCOR AM® 4605 (comprising iron and about 0.46 wt % carbon, about 0.34 wt % oxygen, about 0.03 wt % sulfur, about 0.01 wt % nitrogen, about 1.9 wt % nickel, about 0.4 wt % molybdenum, and about 0.1 wt % silicon).

Also, iron-based powders include tool steels made by powder metallurgy methods.

The term “alloying particle” as used herein refers to a metallurgical powder particle that contains one or more of the alloying elements. In some embodiments, the alloying particles comprise the pure elemental metal (e.g., flakes or powders). In other embodiments, the particles comprise one or more elemental metals pre-alloyed with iron. The alloying elements are generally chosen to enhance one or more properties of the powder or product prepared from the powder. Alloying elements that are incorporated into the composition of this invention are those known in the powder metallurgical industry to enhance mechanical properties, corrosion resistance, strength, hardenability, or other desirable properties of articles produced by powder metallurgical methods. Examples of alloying elements that can be pre-alloyed with iron include, but are not limited to, molybdenum (Mo), manganese (Mn), silicon (Si), vanadium (V), carbon (C) such as graphite, copper (Cu), nickel (Ni), chromium (Cr), phosphorus (P), aluminum (Al), niobium (Nb), among others, or combinations thereof. The amount of the alloying element or elements incorporated depends upon the properties desired in the final metal part. Pre-alloyed iron powders that incorporate such alloying elements are the ANCORSTEEL® line of powders. In some embodiments, the iron-based powder is of iron pre-alloyed with molybdenum (Mo), i.e., Fe-Mo prealloys, or copper (Cu), i.e., Fe-Cu prealloys. In other embodiments, the iron-based powder contains an admixture of two different pre-alloyed iron-based powders. Accordingly, in the practice of this invention, the alloying elements can be incorporated into the compositions in the form of particles or powders of individual alloying elements or pre-alloys of the alloying element with iron. In some embodiments, the diffusion alloyed powder is a composition comprising iron and about 1.75 wt % of nickel, about 0.5 wt % of molybdenum, about 1.5 wt % of copper, less than about 0.01 wt % of carbon, and about 0.13 wt % of oxygen (also known as ANCORSTEEL FD-4800A) or a composition comprising iron and about 4 wt % of nickel, about 0.5 wt % of molybdenum, about 1.5 wt % of copper, less than about 0.01 wt % of carbon, and about 0.13 wt % of oxygen, i.e., a Fe-1.5% Mo prealloy (also known as ANCORSTEEL FLD-49DH).

Pre-alloyed powders can be prepared by making a melt of iron and the one or more alloying elements, and then atomizing the melt, whereby the atomized droplets form the powder upon solidification. In some embodiments, the atomizing is performed using gas atomization whereby inert gas jets atomize the particle. In other embodiments, atomizing is performed using water atomization whereby the molten metal is impinged by jets of water.

In certain embodiments, the iron-based powder composition may be formed of base iron particles in combination with separate particles of the chosen alloying elements. Such compositions will generally contain one or more binding agents to bond the different components present in the metallurgical powder composition so as to inhibit segregation and to reduce dusting. By “bond” as used herein, it is meant any physical or chemical method that facilitates adhesion of the components of the metallurgical powder composition. Binding agents are added to metallurgical powder compositions using techniques known to those skilled in the art. Suitable binding agents are disclosed in U.S. Pat. No. 7,527,667 to Lindsley, et al.

The iron-based powder composition may also be composed of base particles of substantially pure iron or pre-alloyed iron that are diffusion bonded with particles containing at least one further alloying element, which may be the same or different from elements pre-alloyed into the base particles. In some embodiments, at least some of the base iron particles are diffusion bonded with particles containing at least one further alloying element. In some embodiments, at least some of the base iron particles are diffusion bonded with at some of the particles containing at least one further alloying element. The diffusion bonding provides the base iron particles with a layer or coating of the alloying elements diffused into the outer surfaces of the base particles. Diffusion bonding techniques are known in the art and include those described in U.S. Pat. No. 4,238,221 and ASM Handbook, Volume 7, Powder Metallurgy, 2015, which are both incorporated by reference herein. In some embodiments, the diffusion bonding is performed using pressure and heat. The final alloy metal is generated in situ during its use in making the final metal part, such as by press-and sinter methods or in an additive manufacturing process. The preferred diffusion bonded compositions are composed of particles of iron to which are diffusion bonded the alloying elements C, V, Si, Mo, and Mn, in the proportions discussed above. More preferably, at least some of the alloying element, e.g., molybdenum, of the composition is pre-alloyed with the iron to form iron/molybdenum particles. In most preferred embodiments, all of the alloying elements, e.g., molybdenum, of the composition is present through pre-alloying, such that substantially no alloying element, e.g., molybdenum, is present in the powder composition in the form of elemental particles. In yet other preferred embodiments, the manganese, silicon, carbon, and vanadium and any molybdenum not prealloyed with the iron are in the form of elemental particles diffusion bonded to the iron/molybdenum particles.

The term “additive manufacturing” as used herein refers to a method of preparing a metal part using powder metallurgical compositions. One of skill in the art would understand the techniques utilized in additive manufacturing. See, e.g., Milewski, “Additive Manufacturing of Metals,” 1^{st} Ed., XXVI, Springer, 2017; “Laser-Based Additive Manufacturing of Metal Parts: Modeling, Optimization, and Control of Mechanical Properties,” Bian et al., CRC Press, 2017; “Additive Manufacturing Technologies, 3D Printing, Rapid Prototyping, and Direct Digital Manufacturing”, Gibson et al., Springer, 2015; and “Additive Manufacturing: 3D Printing for Prototyping and Manufacturing”, Gebhardt, Carl Hanser Verlag GmbH & Company KG, 2016, all of which are incorporated by reference herein. In some embodiments, additive manufacturing is performed using powder bed fusion where layers of powdered metal are sequentially spread across a plate before being melted by a laser. The unmelted powders are optionally removed before each sequential layer is spread. In some embodiments, such methods use one laser, multiple lasers, or a beam of electrons to selectively melt the layers. Examples of such systems include, without limitation, direct metal laser sintering, direct metal laser melting, and electron beam melting. In other embodiments, the additive manufacturing is binder jet additive manufacturing. As known to those skilled in the art, binder jet additive manufacturing comprises the use of a binder, usually in the form of a liquid, to act as an adhesive between powder layers. Typically, a print head moves horizontally and deposits alternating layers of the build material and the binding material.

Applicants have found that additive manufacturing using powder compositions composed of diffusion bonded powders is particularly efficient in forming strong dense parts. Preferred are compositions in which iron-based particles are diffusion bonded with at least one alloying element. More preferred are compositions containing more than one alloying element, particularly those composed of pre-alloyed iron particles to which are diffusion bonded at least one other alloying element. Most preferred are the compositions described herein in which the alloying materials comprise carbon, silicon, vanadium, manganese, and molybdenum, where at least some of the molybdenum is pre-alloyed into the base iron particles. Examples of iron/molybdenum pre-alloy powders are those containing 0.35-1.5 wt % molybdenum, such as the ANCORSTEEL HP powders. Particularly preferred for this purpose is a prealloy containing about 1.5 wt % molybdenum, such as ANCORSTEEL 150 HP.

The metallurgical powder compositions of the invention can have a volumetric average particle size as small as one micron or below, or up to about 200 microns, preferably about 1 about 150 microns. In further embodiments, the volumetric average particle size of the metallurgical powder composition is about 1 to about 100 microns. In other embodiments, the volumetric average particle size of the metallurgical powder composition is about 1 to about 75 microns. In still further embodiments, the volumetric average particle size of the metallurgical powder composition is about 1 to about 50 microns. In yet other embodiments, the volumetric average particle size of the metallurgical powder composition is about 25 to about 150. In further embodiments, the volumetric average particle size of the metallurgical powder composition is less than about 150 microns. In yet other embodiments, the volumetric average particle size of the metallurgical powder composition is about 1 to about 30 microns, preferably when the composition is to be used in a binder jet. In still further embodiments, the volumetric average particle size of the metallurgical powder composition is about 15 to about 75 microns, preferably when the composition is to be used for laser powder bed fusion. In other embodiments, the volumetric average particle size of the metallurgical powder composition is about 45 to about 150 microns, preferably when the composition is to be used for electron beam melting. In other further embodiments, the volumetric average particle size of the metallurgical powder composition is about 25 to about 45 microns.

In some embodiments, the present disclosure provides iron-based metallurgical compositions, comprising iron and alloying elements of about 0.01 to about 0.65 wt %, based on the weight of the composition, of carbon; about 1 to about 2.0 wt %, based on the weight of the composition, of molybdenum; about 0.25 to about 2.0 wt %, based on the weight of the composition, of manganese; about 0.25 to about 2.0 wt %, based on the weight of the composition, of silicon; and about 0.05 to about 0.6 wt %, based on the weight of the composition, of vanadium. In some embodiments, this iron-based metallurgical composition is a powder metallurgical composition. In other embodiments, this iron-based powder metallurgical composition contains particles of iron that are diffusion bonded with particles of said alloying elements. In further embodiments, this iron-based metallurgical composition contains molybdenum. In other embodiments, this iron-based metallurgical composition contain molybdenum and at least a portion of the molybdenum is pre-alloyed with the iron in the form of iron/molybdenum particles. In still further embodiments, this iron-based metallurgical composition contains alloying powders of manganese, silicon, carbon, and vanadium which are that are diffusion bonded to the iron/molybdenum pre-alloy particles. In still other embodiments, the alloying powders can themselves be composed of pre-alloys of the alloying element and iron.

The iron-based metallurgical composition can contain a very low residual impurities, such as elements commonly found in trace amounts with iron, or oxides thereof. The term “residual element” as used herein refers to one or more elements other than carbon, manganese, molybdenum, vanadium, and silicon. The more common residual elements are chromium, nickel, or copper. The term “oxide” as used herein refers to a solid compound formed when the residual element is oxidized. One of skill in the art would readily understand which oxides may be formed from the “residual elements” noted herein.

Desirably, the iron-based metallurgical compositions contain less than about 2 wt %, based on the weight of the composition, of residual elements or oxides thereof. In further embodiments, the iron-based metallurgical composition comprises less than about 1 wt %, based on the weight of the composition, of residual elements or oxides thereof. In other embodiments, the iron-based metallurgical composition comprises about 0.001 to about 0.5 wt %, based on the weight of the composition, of residual elements or oxides thereof. In still further embodiments, the iron-based metallurgical composition comprises about 0.001 to about 0.25 wt %, based on the weight of the composition of residual elements or oxides thereof. In yet other embodiments, the iron-based metallurgical composition comprises about 0.001 to about 0.1 wt %, based on the weight of the composition, of residual elements or oxides thereof.

As discussed, the iron-based metallurgical compositions described herein comprise about 0.01 to about 0.65 wt %, based on the weight of the composition, of carbon. In other embodiments, the iron-based metallurgical composition comprises about 0.05 to about 0.6 wt %, based on the weight of the composition, of carbon. In other embodiments, the iron-based metallurgical composition comprises about 0.05 to about 0.55 wt %, based on the weight of the composition, of carbon. In further embodiments, the iron-based metallurgical composition comprises about 0.05 to about 0.5 wt %, based on the weight of the composition, of carbon. In still other embodiments, the iron-based metallurgical composition comprises about 0.1 to about 0.25 wt %, based on the weight of the composition, of carbon.

The iron-based metallurgical compositions also comprise about 1 to about 2.0 wt %, based on the weight of the composition, of molybdenum. In other embodiments, the iron-based metallurgical composition comprises about 1.1 to about 1.7 wt %, based on the weight of the composition, of molybdenum. In further embodiments, the iron-based metallurgical composition comprises about 1.2 to about 1.5 wt %, based on the weight of the composition, of molybdenum. In still other embodiments, the iron-based metallurgical composition comprises about 1.25 to about 1.4 wt %, based on the weight of the composition, of molybdenum.

The iron-based metallurgical compositions further comprise about 0.25 to about 2.0 wt %, based on the weight of the composition, of manganese. In other embodiments, the iron-based metallurgical composition comprises about 0.8 to about 1.4 wt %, based on the weight of the composition, of manganese. In further embodiments, the iron-based composition contains about 0.9 to about 1.3 wt %, based on the weight of the composition, of manganese. In still other embodiments, the iron-based metallurgical composition comprises about 0.93 to about 1.15 wt %, based on the weight of the composition, of manganese.

The iron-based metallurgical compositions also comprise about 0.25 to about 2.0 wt %, based on the weight of the composition, of silicon. In other embodiments, the iron-based metallurgical composition comprises about 0.8 to about 1.4 wt %, based on the weight of the composition, of silicon. In further embodiments, the iron-based composition comprises about 0.8 to about 1.3 wt %, based on the weight of the composition, of silicon. In still other embodiments, the iron-based composition comprises about 0.9 to about 1.2 wt %, based on the weight of the composition, of silicon. In yet further embodiments, the iron-based composition comprises about 0.93 to about 1.15 wt %, based on the weight of the composition, of silicon.

The iron-based metallurgical compositions further comprise about 0.05 to about 0.6 wt %, based on the weight of the composition, of vanadium. In other embodiments, the iron-based metallurgical composition comprises about 0.08 to about 0.4 wt %, based on the weight of the composition, of vanadium. In further embodiments, the iron-based metallurgical composition comprises about 0.1 to about 0.25 wt %, based on the weight of the composition, of vanadium. In preferred embodiments, the iron-based powder metallurgical composition comprises about 0.05 to about 0.54 wt %, based on the weight of the composition, of carbon; about 1.26 to about 1.4 wt %, based on the weight of the composition, of molybdenum; about 0.93 to about 1.25 wt %, based on the weight of the composition, of manganese; about 0.93 to about 1.15 wt %, based on the weight of the composition, of silicon; and about 0.1 to about 0.25 wt %, based on the weight of the composition, of vanadium.

In further preferred embodiments, the iron-based powder metallurgical composition comprises about 0.23 to about 0.54 wt %, based on the weight of the composition, of carbon; about 1.26 to about 1.4 wt %, based on the weight of the composition, of molybdenum; about 0.93 to about 1.25 wt %, based on the weight of the composition, of manganese; about 0.93 to about 1.15 wt %, based on the weight of the composition, of silicon; and about 0.12 to about 0.2 wt %, based on the weight of the composition, of vanadium.

In other preferred embodiments, the iron-based powder metallurgical composition comprises about 0.15 to about 0.65 wt %, based on the weight of the composition, of carbon; about 1 to about 1.6 wt %, based on the weight of the composition, of molybdenum; about 0.75 to about 1.5 wt %, based on the weight of the composition, of manganese; about 0.75 to about 1.5 wt %, based on the weight of the composition, of silicon; and about 0.05 to about 0.3 wt %, based on the weight of the composition, of vanadium.

In still further preferred embodiments, the iron-based powder metallurgical composition comprises about 0.54 wt %, based on the weight of the composition, of carbon; about 1.34 wt %, based on the weight of the composition, of molybdenum; about 0.94 wt %, based on the weight of the composition, of manganese; about 0.93 wt %, based on the weight of the composition, of silicon; and about 0.12 wt %, based on the weight of the composition, of vanadium.

In yet other preferred embodiments, the iron-based powder metallurgical composition comprises about 0.23 wt %, based on the weight of the composition, of carbon; about 1.39 wt %, based on the weight of the composition, of molybdenum; about 1 wt %, based on the weight of the composition, of manganese; about 1.02 wt %, based on the weight of the composition, of silicon; and about 0.14 wt %, based on the weight of the composition, of vanadium.

In further preferred embodiments, the iron-based powder metallurgical composition comprises about 0.24 wt %, based on the weight of the composition, of carbon; about 1.4 wt %, based on the weight of the composition, of molybdenum; about 1.09 wt %, based on the weight of the composition, of manganese; about 1.15 wt %, based on the weight of the composition, of silicon; and about 0.17 wt %, based on the weight of the composition, of vanadium.

In other preferred embodiments, the iron-based powder metallurgical composition comprises about 0.23 wt %, based on the weight of the composition, of carbon; about 1.26 wt %, based on the weight of the composition, of molybdenum; about 1.25 wt %, based on the weight of the composition, of manganese; about 0.96 wt %, based on the weight of the composition, of silicon; and about 0.2 wt %, based on the weight of the composition, of vanadium.

The present invention also provides methods for using iron-based metallurgical powders. The iron-based metallurgical powders are generally used to make metal parts. One such method of use comprises compacting the metal powders, generally in a mold, to form an intermediate compacted “green” part, which is then sintered to form the final part.

The present disclosure is also directed to methods of additive manufacturing a metal part using the iron-based powder compositions of the invention. The preferred form of the powder composition for this use comprises iron particles diffusion bonded with one or more of the alloying elements.

In some embodiments, the iron particles are substantially pure iron as described herein. In other embodiments, the iron particles are an iron prealloy as described herein. In preferred embodiments, the iron particles are an iron prealloy that is an iron-molybdenum prealloy as described herein.

The additive manufacturing methods comprise forming two or more sequentially applied layers of the metallurgical powder composition described herein. In some embodiments, the layers are formed by fusing. Thus, in these methods for additive manufacturing a metal part from a metallurgical powder composition by forming two or more sequentially applied layers of the metallurgical composition, the improvement wherein the metallurgical powder composition comprises base-iron particles diffusion bonded with one or more alloying elements as described herein. In some embodiments, the layers are formed by fusing.

### ASPECTS

Aspect 1. An iron-based metallurgical composition, comprising iron and alloying elements of:

about 0.01 to about 0.65 wt %, based on the weight of the composition, of carbon; about 1 to about 2.0 wt %, based on the weight of the composition, of molybdenum; about 0.25 to about 2.0 wt %, based on the weight of the composition, of manganese; about 0.25 to about 2.0 wt %, based on the weight of the composition, of silicon; and about 0.05 to about 0.6 wt %, based on the weight of the composition, of vanadium.

Aspect 2. The iron-based metallurgical composition of Aspect 1 that is a powder metallurgical composition.

Aspect 3. The iron-based metallurgical composition of Aspect 2, wherein the composition contains particles of iron pre-alloyed with at least one of the alloying elements.

Aspect 4. The iron-based metallurgical composition of Aspect 2 or 3 wherein the composition contains particles of iron that are diffusion bonded with particles of at least one of said alloying elements.

Aspect 5. The iron-based metallurgical composition of Aspect 4, wherein the particles of iron are diffusion bonded with particles of each of said alloying elements.

Aspect 6. The iron-based metallurgical composition of Aspect 2 or 4, wherein at least a portion of the molybdenum present in the composition is pre-alloyed with the iron in the form of iron/molybdenum particles.

Aspect 7. The iron-based metallurgical composition of Aspect 6, wherein said manganese, silicon, carbon, and vanadium are in the form of elemental powders that are diffusion bonded to said iron/molybdenum pre-alloy particles.

Aspect 8. The iron-based metallurgical composition of Aspect 4 wherein at least a portion of the molybdenum present in the composition is pre-alloyed with the iron in the form of iron/molybdenum base particles and at least one of said manganese, silicon, carbon, and vanadium is pre-alloyed with iron to form alloying particles separate from the base iron particles.

Aspect 9. The iron-based metallurgical composition of any one of the preceding Aspects, comprising less than about 2 wt %, based on the weight of the composition, of residual elements or oxides thereof.

Aspect 10. The iron-based metallurgical composition of Aspect 8, comprising about 0.001 to about 1 wt %, preferably about 0.001 to about 0.5 wt %, about 0.001 to about 0.25 wt %, or about 0.001 to about 0.1 wt %, based on the weight of the composition, of residual elements or oxides thereof.

Aspect 11. The iron-based metallurgical composition of any one of the preceding Aspects, comprising about 0.05 to about 0.6 wt %, preferably about 0.05 to about 0.58 wt %, preferably about 0.05 to about 0.56 wt %, or preferably about 0.05 to about 0.25 wt %, based on the weight of the composition, of carbon.

Aspect 12. The iron-based metallurgical composition of any one of the preceding Aspects, comprising about 1.1 to about 1.5 wt %, preferably about 1.2 to about 1.4 wt %, or preferably about 1.26 to about 1.4 wt %, based on the weight of the composition, of molybdenum.

Aspect 13. The iron-based metallurgical composition of any one of the preceding Aspects, comprising about 0.8 to about 1.4 wt %, preferably about 0.9 to about 1.3 wt %, or preferably about 0.93 to about 1.15 wt %, based on the weight of the composition, of manganese.

Aspect 14. The iron-based metallurgical composition of any one of the preceding Aspects, comprising about 0.8 to about 1.4 wt %, preferably about 0.8 to about 1.3 wt %, preferably about 0.9 to about 1.2 wt %, or preferably about 0.93 to about 1.15 wt %, based on the weight of the composition, of silicon.

Aspect 15. The iron-based metallurgical composition of any one of the preceding Aspects, comprising about 0.08 to about 0.25 wt %, preferably about 0.1 to about 0.25 wt %, or preferably about 0.12 to about 0.23 wt %, based on the weight of the composition, of vanadium.

Aspect 16. An iron-based powder metallurgical composition comprising:
base-iron particles and particles containing one or more of carbon, molybdenum, manganese, silicon, and vanadium as alloying elements, wherein the composition contains:
about 0.05 to about 0.54 wt %, based on the weight of the composition, of carbon;
about 1.26 to about 1.4 wt %, based on the weight of the composition, of molybdenum;
about 0.93 to about 1.25 wt %, based on the weight of the composition, of manganese;
about 0.93 to about 1.15 wt %, based on the weight of the composition, of silicon; and
about 0.12 to about 0.2 wt %, based on the weight of the composition, of vanadium.

Aspect 17. The iron-based metallurgical powder composition of any one of Aspects 2 to 16 wherein the base-iron particles are prepared by gas atomization or water atomization.

Aspect 18. A pressed and sintered metal part made from the iron-based metallurgical powder composition of Aspect 17.

Aspect 19. A metal part made by additive manufacturing using the iron-based metallurgical powder composition of Aspect 17.

Aspect 20. A method of additive manufacturing a metal part from a metallurgical powder composition, wherein the metallurgical powder composition comprises base-iron particles diffusion bonded with one or more alloying elements and the method comprises forming two or more sequentially applied layers of the metallurgical powder composition.

Aspect 21. The method of Aspect 20, wherein the two or more sequentially applied layers of the metallurgical powder composition are formed by fusing.

Aspect 22. The method of Aspect 20 or 21, wherein the iron particles are substantially pure iron.

Aspect 23. The method of Aspect 20 or 21, wherein the iron particles are an iron prealloy.

Aspect 24. The method of Aspect 23, wherein the iron prealloy is prepared using gas atomization or water atomization.

Aspect 25. The method of Aspect 23 or 24, wherein the iron prealloy is an iron-molybdenum prealloy.

Aspect 26. A method of additive manufacturing a metal part from a metallurgical powder composition, wherein the metallurgical powder composition comprises iron and alloying elements of:
about 0.1 to about 0.65 wt %, based on the weight of the composition, of carbon;
about 1 to about 1.6 wt %, based on the weight of the composition, of molybdenum;
about 0.75 to about 1.5 wt %, based on the weight of the composition, of manganese;
about 0.75 to about 1.5 wt %, based on the weight of the composition, of silicon; and
about 0.05 to about 0.3 wt %, based on the weight of the composition, of vanadium;
wherein at least a portion of the molybdenum present in the composition is pre-alloyed with the iron in the form of iron/molybdenum particles.

Aspect 27. The method of Aspect 26 wherein said manganese, silicon, carbon, and vanadium and any molybdenum not prealloyed with the iron are in the form of elemental particles diffusion bonded to the iron/molybdenum particles.

Aspect 28. An iron-based powder metallurgical composition comprising: base-iron particles of iron pre-alloyed with molybdenum and particles containing one or more of carbon, manganese, silicon, and vanadium as alloying elements, wherein the composition contains:
about 0.05 to about 0.54 wt %, based on the weight of the composition, of carbon;
about 1.26 to about 1.4 wt %, based on the weight of the composition, of molybdenum;
about 0.93 to about 1.25 wt %, based on the weight of the composition, of manganese;
about 0.93 to about 1.15 wt %, based on the weight of the composition, of silicon; and
about 0.12 to about 0.2 wt %, based on the weight of the composition, of vanadium.

Aspect 29. The powder composition of Aspect 16 or Aspect 28 wherein the alloying particles are substantially pure powders of individual alloying elements.

30. The powder composition of Aspect 28 or 29 wherein the alloying particles are diffusion bonded to said base-iron particles.

Aspect 31. The powder composition of Aspect 16 or Aspect 28 wherein the alloying particles of at least some of said alloying elements are in the form of iron pre-alloyed with said element.

Aspect 32. The powder composition of Aspect 31 wherein the alloying particles are diffusion bonded to said base-iron particles.

Aspect 33. In a method for additive manufacturing a metal part from a metallurgical powder composition by fusing two or more sequentially applied layers of the metallurgical composition, the improvement wherein the metallurgical powder composition comprises base-iron particles diffusion bonded with one or more alloying elements.

The following Examples are provided to illustrate some of the concepts described within this disclosure. While each Example is considered to provide specific individual embodiments of composition, methods of preparation and use, none of the Examples should be considered to limit the more general embodiments described herein.

### EXAMPLES

In the following examples, unless indicated otherwise, temperature is in degrees C., pressure is at or near atmospheric.

### Example 1

Iron-based metallurgical compositions were prepared by combining a base iron containing about 1.5% prealloyed molybdenum and carbon, molybdenum, manganese, silicon, and vanadium (added either as elemental or ferroalloy powders) in the amounts noted in Table 1.

TABLE 1

| | Wt (%) | | | | |
|---|---|---|---|---|---|
| Composition | C | Mo | Mn | Si | V |
| 1 | 0.54 | 1.34 | 0.93 | 0.93 | 0.12 |
| 2 | 0.23 | 1.39 | 1.0 | 1.02 | 0.14 |
| 3 | 0.24 | 1.4 | 1.09 | 1.15 | 0.17 |
| 4 | 0.23 | 1.26 | 1.25 | 0.96 | 0.2 |

Powders of each composition were then produced using water atomization plus diffusion alloying or gas atomization. Powders produced by water atomization plus diffusion alloying were made by combining iron and molybdenum and subjecting to water atomization. Mn, Si and V containing additives were diffusion alloyed to the water atomized base powder and carbon was added by diffusion alloying. Gas atomization was performed by combining all elements in the molten state (prealloying) and subjecting to gas atomization. Test metal part specimens were prepared with compositions 1-3 using a laser powder bed fusion technique and an EOS M290 instrument. The printed specimens were then tempered in a conventional tempering oven for 1 hour in a nitrogen atmosphere at the temperature shown in Table 2. Tensile properties and hardness were then measured on the samples using techniques known in the art. As shown in Table 2, very high strength and ductility values were obtained. See, Table 2.

TABLE 2

| | | | 0.2% | | |
|---|---|---|---|---|---|
| | Post | UTS | YS | Elongation | Hardness |
| Alloy* | Build | (MPa) | (MPa) | (%) | (HRA) |
| Water | Tempered | 1331 | 1200 | 13.0 | 72 |
| Atomized (LC) | 427° C. | | | | |
| Composition 2 | | | | | |
| Water | Tempered | 1345 | 1227 | 12.7 | 72 |
| Atomized (LC) | 449° C. | | | | |
| Composition 2 | | | | | |
| Water | Tempered | 1427 | 1276 | 12.8 | 75 |
| Atomized (LC) | 538° C. | | | | |
| Composition 2 | | | | | |
| Gas Atomized | Tempered | 1289 | 1062 | 14.3 | 70 |
| (LC) | 538° C. | | | | |
| Composition 3 | | | | | |
| Water | Tempered | 1756 | 1468 | 6.4 | 74 |
| Atomized (HC) | 538° C. | | | | |
| Composition 1 | | | | | |

*LC = low carbon; HC = high carbon

### Example 2

Composition 5 was prepared by combining an iron based powder with silicon, vanadium, manganese, molybdenum, nickel, and chromium in the amounts noted in Table 3. A comparative composition of prealloyed steel powder prealloy 20MnCr5, which is a gas atomized powder available from Hoeganaes.

TABLE 3

| Composition | Si | V | Mn | Mo | Ni | Cr |
|---|---|---|---|---|---|---|
| 5 | 1.23 | 0.17 | 1.01 | 1.48 | 0 | 0 |
| Comparative | 0.62 | 0 | 1.35 | 0.02 | 0.02 | 1.21 |

Composition 5 and the comparative composition were then used to prepare a metal part as described in Example 1. Each metal part was then tested for its ultimate tensile strength (UTS), yield strength (YS), elongation, and hardness. See, Table 4.

TABLE 4

| | | UTS | 0.2% YS | Elongation | Hardness |
|---|---|---|---|---|---|
| Composition | Condition | (MPa) | (MPa) | (%) | (HRA) |
| 5 | As Built | 1425 | 1347 | 11.9 | 74 |
| Comparative | As Built | 1207 | 986 | 15.2 | 69 |

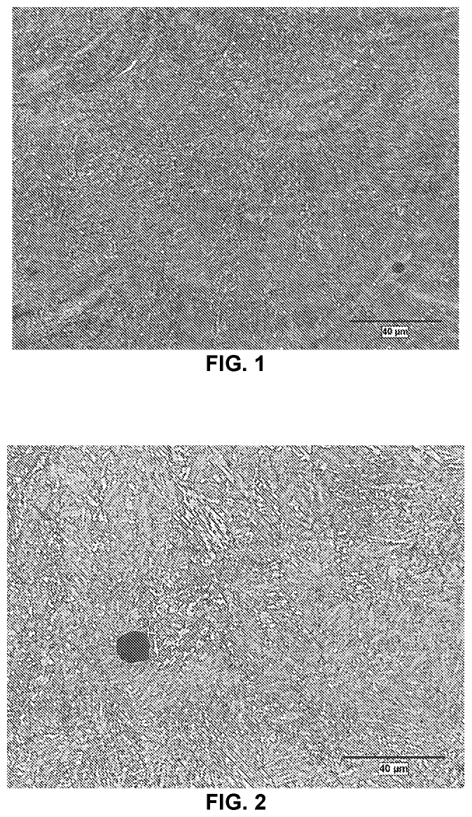

These results illustrated that metal parts prepared from Composition 5 had significantly higher strength than metal parts prepared from 20MnCr5 under the same processing conditions. An image of composition 5 was obtained. See, FIG. 1 which shows fine microstructure of the resultant product.

The contents of all references, patent applications, patents, and published patent applications, as well as the Figures, cited throughout this application are hereby incorporated by reference.

Those skilled in the art will recognize, or be able to ascertain using no more than routine experimentation, many equivalents to the specific embodiments of the disclosure described herein. Such equivalents are intended to be encompassed by the following claims.

1. An iron-based metallurgical composition, comprising iron as a base element and alloying elements of:
about 0.01 to about 0.65 wt %, based on the weight of the composition, of carbon;
about 1 to about 2.0 wt %, based on the weight of the composition, of molybdenum;
about 0.25 to about 2.0 wt %, based on the weight of the composition, of manganese;
about 0.25 to about 2.0 wt %, based on the weight of the composition, of silicon; and
about 0.05 to about 0.6 wt %, based on the weight of the composition, of vanadium.

2. The iron-based metallurgical composition of claim 1 that is a powder metallurgical composition.

3. The iron-based metallurgical composition of claim 2, wherein the composition contains particles of iron pre-alloyed with at least one of the alloying elements.

4. The iron-based metallurgical composition of claim 2, wherein the composition contains particles of iron that are diffusion bonded with particles of at least one of said alloying elements.

5. The iron-based metallurgical composition of claim 4, wherein the particles of iron are diffusion bonded with particles of each of said alloying elements.

6. The iron-based metallurgical composition of claim 2, wherein at least a portion of the molybdenum present in the composition is pre-alloyed with the iron in the form of iron/molybdenum particles.

7. The iron-based metallurgical composition of claim 6, wherein said manganese, silicon, carbon, and vanadium are in the form of elemental powders that are diffusion bonded to said iron/molybdenum pre-alloy particles.

8. The iron-based metallurgical composition of claim 4, wherein at least a portion of the molybdenum present in the composition is pre-alloyed with the iron in the form of iron/molybdenum base particles and at least one of said manganese, silicon, carbon, and vanadium is pre-alloyed with iron to form alloying particles separate from the base iron particles.

9. The iron-based metallurgical composition of claim 1, comprising less than about 2 wt %, based on the weight of the composition, of residual elements or oxides thereof.

10. The iron-based metallurgical composition of claim 9, comprising about 0.001 to about 1 wt %, based on the weight of the composition, of residual elements or oxides thereof.

11. The iron-based metallurgical composition of claim 1, comprising about 0.05 to about 0.6 wt %, based on the weight of the composition, of carbon.

12. The iron-based metallurgical composition of claim 1, comprising about 1.1 to about 1.5 wt %, based on the weight of the composition, of molybdenum.

13. The iron-based metallurgical composition of claim 1, comprising about 0.8 to about 1.4 wt %, based on the weight of the composition, of manganese.

14. The iron-based metallurgical composition of claim 1, comprising about 0.8 to about 1.4 wt %, based on the weight of the composition, of silicon.

15. The iron-based metallurgical composition of claim 1, comprising about 0.08 to about 0.25 wt %, based on the weight of the composition, of vanadium.

16. The iron-based metallurgical powder composition of claim 2, wherein the base-iron particles are prepared by gas atomization or water atomization.

17. The iron-based powder metallurgical composition of claim 1, comprising:
base-iron particles and particles containing one or more of carbon, molybdenum, manganese, silicon, and vanadium as alloying elements;
about 0.05 to about 0.54 wt %, based on the weight of the composition, of carbon;
about 1.26 to about 1.4 wt %, based on the weight of the composition, of molybdenum;
about 0.93 to about 1.25 wt %, based on the weight of the composition, of manganese;
about 0.93 to about 1.15 wt %, based on the weight of the composition, of silicon; and
about 0.12 to about 0.2 wt %, based on the weight of the composition, of vanadium.

18. The iron-based metallurgical powder composition of claim 17, wherein the base-iron particles are prepared by gas atomization or water atomization.

19. The iron-based metallurgical powder composition of claim 17, wherein the alloying particles are substantially pure powders of individual alloying elements.

20. The iron-based metallurgical powder composition of claim 19, wherein at least some of the alloying particles are diffusion bonded to said base-iron particles.

21. The iron-based metallurgical powder composition of claim 17, wherein at least some of said alloying elements are pre-alloyed with the iron.

22. The iron-based metallurgical powder composition of claim 21, wherein the alloying particles are diffusion bonded to said base-iron particles.

23. A pressed and sintered metal part made from the iron-based metallurgical powder composition of claim 1.

24. A metal part made by additive manufacturing using the iron-based metallurgical powder composition of claim 1.

25. A method of additive manufacturing a metal part from a metallurgical powder composition, wherein the metallurgical powder composition comprises base-iron particles diffusion bonded with one or more alloying elements and the method comprises forming two or more sequentially applied layers of the metallurgical powder composition.

26. The method of claim 25, wherein the two or more sequentially applied layers of the metallurgical powder composition are formed by fusing.

27. The method of claim 25, wherein the iron particles are substantially pure iron.

28. The method of claim 25, wherein the iron particles are an iron prealloy.

29. The method of claim 28, wherein the iron prealloy is prepared using gas atomization or water atomization.

30. The method of claim , wherein the iron prealloy is an iron-molybdenum prealloy.

31. A method of additive manufacturing a metal part from the metallurgical powder composition of claim 1, wherein the metallurgical powder composition comprises:
about 0.1 to about 0.65 wt %, based on the weight of the composition, of carbon;
about 1 to about 1.6 wt %, based on the weight of the composition, of molybdenum;
about 0.75 to about 1.5 wt %, based on the weight of the composition, of manganese;
about 0.75 to about 1.5 wt %, based on the weight of the composition, of silicon; and
about 0.05 to about 0.3 wt %, based on the weight of the composition, of vanadium;
wherein at least a portion of the molybdenum present in the composition is pre-alloyed with the iron in the form of iron/molybdenum particles.

32. The method of claim 31, wherein said manganese, silicon, carbon, and vanadium and any molybdenum not prealloyed with the iron are in the form of elemental particles diffusion bonded to the iron/molybdenum particles.

33. The iron-based powder metallurgical composition of claim 17, wherein the
base-iron particles are pre-alloyed with molybdenum and the particles containing one or more of carbon, manganese, silicon, and vanadium.

34. The iron-based powder metallurgical composition of claim 33, wherein the alloying particles are substantially pure powders of individual alloying elements.

35. The iron-based powder metallurgical composition of claim 33, wherein at least some of the alloying particles are diffusion bonded to said base-iron particles.

36. The iron-based powder metallurgical composition of claim 31, wherein at least some of the alloying particles are pre-alloyed with the iron.

37. The iron-based powder metallurgical composition of claim 36, wherein the alloying particles are diffusion bonded to said base-iron particles.

38. In a method for additive manufacturing a metal part from a metallurgical powder composition by fusing two or more sequentially applied layers of the metallurgical composition, the improvement wherein the metallurgical powder composition comprises base-iron particles diffusion bonded with one or more alloying elements.
